(19) United States
(12) Patent Application Publication
(10) Pub. No.: US 2012/0227763 A1
(43) Pub. Date: Sep. 13, 2012

(54) FLOOR MOP

(76) Inventors: Eric Paris Hayes, Denver, CO (US); Jared Mark Delaney Hall, Aurora, CO (US)

(21) Appl. No.: 13/043,092

(22) Filed: Mar. 8, 2011

(51) Int. Cl. A47L 13/22; B08B 3/04

(52) U.S. Cl. 134/6; 401/138; 401/139

(57) ABSTRACT

A floor mop including a mop head; a bow shaped handle having a distal end positioned remote from the mop head, a proximal end pivotably attached to the mop head, a concave side and a convex side opposite the concave side, the bow shaped handle being pivotably displaceable relative the mop head between a convex side up operating position and a concave side up operating position; and a fluid dispenser mounted on the bow shaped handle.

### BACKGROUND

Floor mops have been used to clean floor surfaces such as hardwood floors, tile floors, granite floors and the like for hundreds of years. A mop includes a mop head which is moved across a floor to be cleaned and an elongate mop handle which is attached to the mop head. Mop heads come in various configurations depending upon the particular utility of the mop. For example, some mop heads include a rigid plate member to which other, softer, cleaning devices are attached. For example, a cleaning cloth might be attached to such a rigid plate as by hook and fastener type strips, tie-on cords, clamps or other attachment means.

In some mops the mop handle is mounted on the mop head through a universal pivot assembly or knuckle that allows pivotal displacement of the handle relative to the mop head about two different pivot axes. Most mop handles are straight, but curved mop handles, mop handles with pistol grips, etc., are also known in the art. Recently, straight handled floor mops have been provided with fluid dispensing systems mounted on the mop handle. A user actuates a fluid dispensing system through a handle mounted trigger to dispense floor cleaning fluid or the like as the mop is moved across the floor. Some mops use an aerosol type fluid dispenser while others employ a mechanical pump assembly to dispense cleaning fluid.

### BRIEF DESCRIPTION OF THE DRAWINGS

FIG. 1 is a perspective view of a floor mop.

FIG. 2 is a right side elevation view of the floor mop of FIG. 1 in a first cleaning position.

FIG. 3 is a left side elevation view of the floor mop of FIG. 1 in a second cleaning position.

FIG. 4 is an exploded view of a first portion of the mop handle of the floor mop of FIG. 1.

FIG. 5 is a detailed cross-sectional elevation view of the mop handle first portion with a cam member and cam follower in a first operating position.

FIG. 6 is a detailed cross-sectional elevation view of the mop handle first portion with the cam member and cam follower in a second operating position.

FIG. 7 is an exploded detailed perspective view of the floor mop of FIG. 1.

FIG. 8 is an elevation view of the floor mop of FIG. 1 being used to clean a floor surface under a chair.

FIG. 9 is an exploded view of an alternative embodiment of the first portion of the mop handle.

FIG. 10 is a detailed cross-sectional elevation view of the mop handle first portion embodiment of FIG. 9 with a cam member and cam follower in a first operating position.

FIG. 11 is a detailed cross-sectional elevation view of the mop handle first portion embodiment of FIG. 9 with a cam member and cam follower in a second operating position.

### DETAILED DESCRIPTION

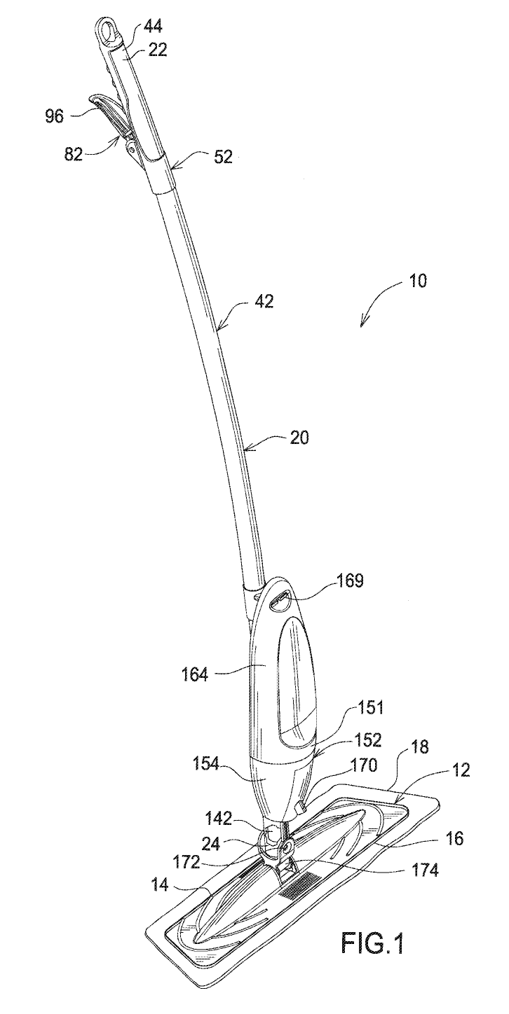

FIG. 1 illustrates a floor mop 10 having a conventional mop head 12 with a trailing edge 14 and a leading edge 16. A cleaning pad 18 may be attached to the mop head 12 as by hook and loop type fasteners strips (not shown) mounted on the bottom of the mop head or by adhesives strips, tie-on cords or other cleaning pad attachment means.

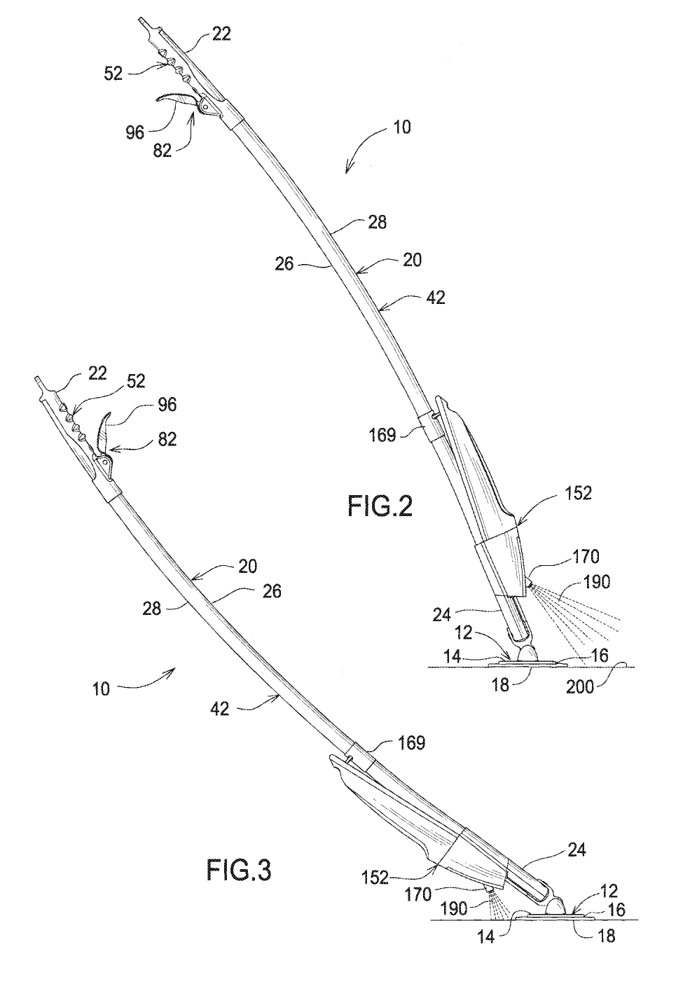

A bow shaped handle 20 is pivotally attached to the mop head 12. Bow shaped handle 20 has a distal end 22 positioned remotely from the mop head and a proximal end 24 positioned near the mop head 12. Bow shaped handle 20 may have a circular cross section and has a concave side 26, FIGS. 2 and 3, which is normally the trailing side of the mop, and has a convex side 28, which is normally the leading side of mop handle 20.

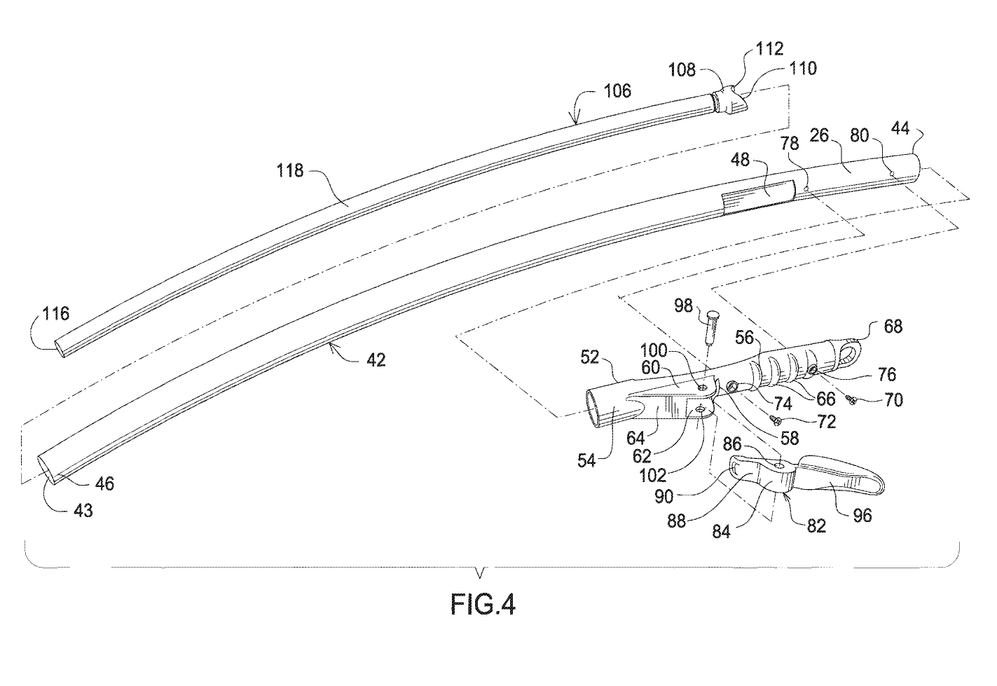

Bow shaped handle 20 includes a first, relatively longer, handle portion 42, which may be a tubular member with a cylindrical cavity 43 and which may be constructed from relatively high strength material such as aluminum, carbon fiber, high strength plastic or the like. First handle portion 42 has a first end 44 and second end 46 as best shown in FIG. 4. The radius of curvature of handle portion 42 may be between 200 cm and 300 cm. In one embodiment handle portion 42 has a cord length of about 97 cm and radius of curvature of about 239 cm. A cut out 48 is provided near the first end 44 of first handle portion 42, e.g. 12 cm from the terminal end. As illustrated best in FIG. 4, a grip member 52 is mounted at the first end 44 of the first handle portion 42. The grip member 52 may have a sleeve portion 54 which receives the tubular first handle portion 42 in close sliding relationship. The grip member 52 has an elongate portion 56 with an arcuate cross section that is adapted to fit closely against the concave side 26 of the first handle portion 42. A cut out 58 is provided in elongate portion 56. Cutout 58 is generally the same size as cut out 48 in the first handle portion 42. Cam mounting flanges 60, 62 are mounted on an end of the elongate portion 56 near the sleeve portion 54. The cam mounting flanges 60, 62 may be connected by a skirt portion 64. Handle gripping surfaces 66 are formed at the upper end of elongate portion 56. An end ring 68 is provided at a terminal end of the grip member 52. Screws 70, 72 are adapted to be received in counter sunk holes 74, 76 extending through elongate portion 56 to attach the grip member 52 to the first handle portion 42. First handle portion 42 comprises bores 78, 80 therein, into which the ends of screws 70, 72 are threaded.

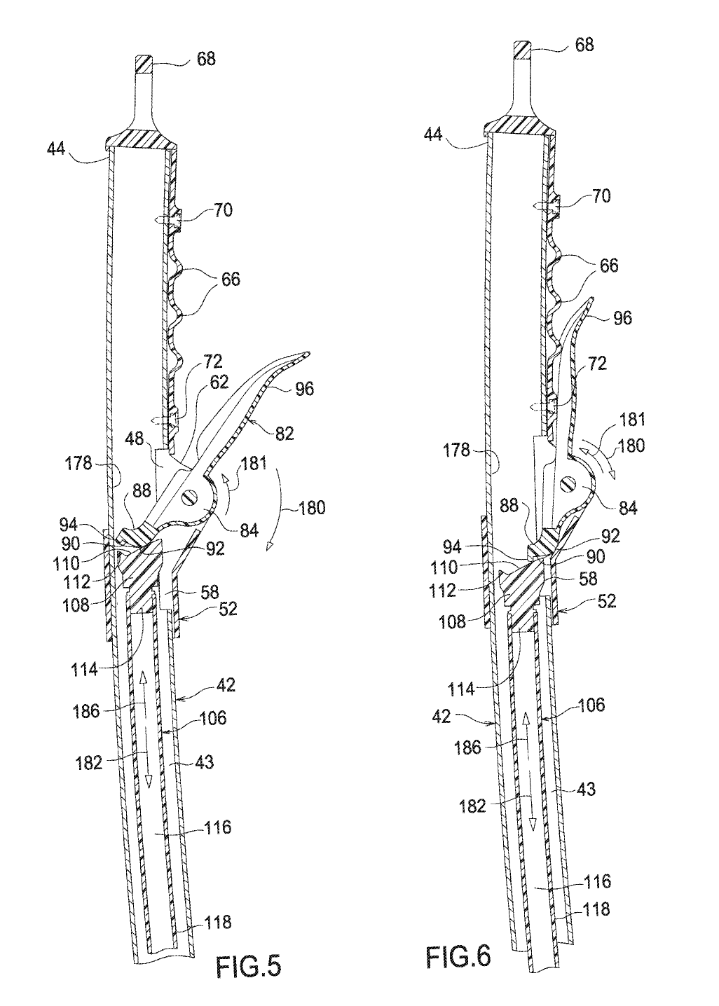

As best illustrated by FIG. 4, a cam member 82 has a central body portion 84 with a cylindrical hole 86 extending through it. A first end 88 of the cam member 82 has a cam surface 90 thereon that includes a heel portion 92 and a toe portion 94, FIGS. 5 and 6. The cam member 82 includes an elongate trigger portion 96 at its second end. The trigger portion 96 may extend about 8 cm from the center of hole 86. A pin 98 may be received through holes 100, 102 in flanges 60, 62 and hole 86 in the cam member 82 to pivotally mount the cam member 82 on the grip member 52.

As best illustrated by FIG. 4, an elongate cam follower 106 may include a cam engagement portion, for example, a plastic member 108 having an axial length of about 2.5 cm. Member 108 may have a beveled surface portion 110 and a tooth surface portion 112 provided on a face thereof. A plug portion 114 is provided at one end of the cam engagement portion 108 and is adapted to be inserted into a cylindrical cavity 116 of a flexible, relatively incompressible tubular member 118 which may be made of, for example, PVC plastic or similar relatively stiff, high strength material. Member 118 may have an outer diameter of about 1.5 cm, an inner diameter of about 1.3 cm and a length of about 77.5 cm. The elongate cam follower 106 is inserted into first tubular handle member 42 such that the cam engagement member 108 thereof is positioned near the opening 48 in the first handle portion 42 as best illustrated in FIGS. 5 and 6.

The handle attachment member 52 is mounted such that opening 58 therein is aligned with opening 48 in the first handle member 42. Cam member 82 is pivotally mounted on flanges 60, 62 such that the first end 88 thereof is positioned at least partially within the cylindrical cavity 43 of the first handle portion 42 with the cam surface 90 of the cam member 82 positioned in engagement with the beveled surface portion 110 of the elongate cam follower 106. Operation of the cam member 82 and the elongate cam follower 106 will be described in further detail below.

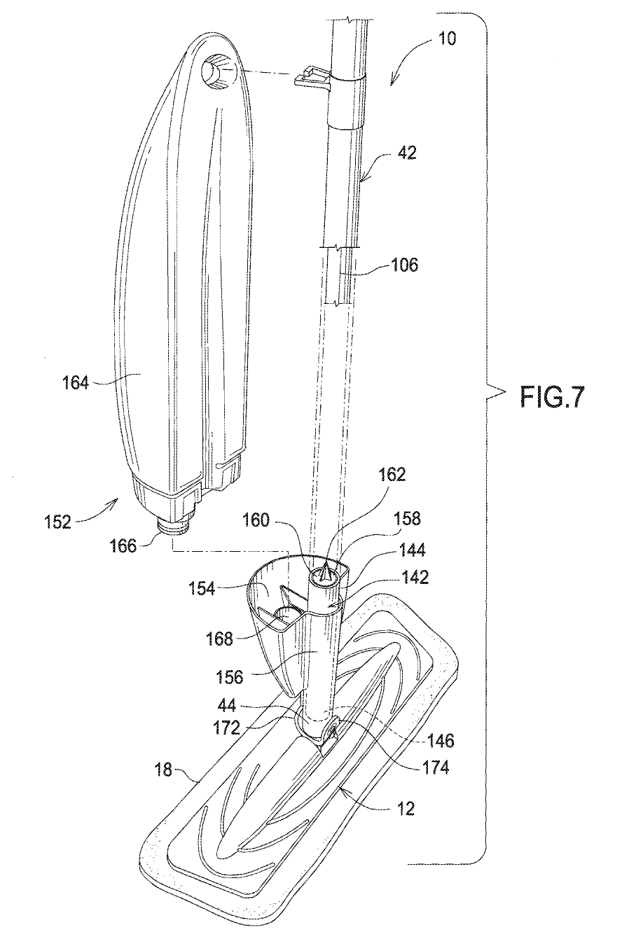

A second relatively shorter handle portion 142 may be a tubular member which may be constructed from aluminum, high strength plastic, carbon fiber, or other relatively strong and light weight material, FIGS. 1 and 7. The second handle portion 142 has a first end 144, FIG. 7, which may be adapted to mate with the second end 46 of the first handle portion 42, FIG. 4. The second handle portion 142 has a second end 146 which is adapted to be pivotally connected to the mop head 12 is described below. In one embodiment the second handle portion 142 has a length of about 20 cm.

A fluid dispense assembly 152, as best shown in FIG. 7, includes a fluid reservoir member 154 which is attached to the second handle portion 142 as by integral sleeve portion 156. A mechanical pump assembly 158 is mounted in the first end 144 of the second relatively shorter handle portion 142. The pump is in fluid communication with a reservoir (not shown) inside the reservoir member 154. The mechanical pump 158 includes a reciprocal pump member 160 which is biased in the upward position illustrated in FIG. 7. A retained spike 162 may be mounted at the top of the pump member 160 and is adapted to connect the pump member 160 to end 116 of elongate cam follower 106, FIG. 4. The fluid dispenser assembly 152 also includes a fluid supply tank 164 which holds cleaning fluid or the like. Fluid supply tank 164 may comprise a tank head portion 166 which is adapted to be received in a mouth portion 168 of the fluid reservoir member 154 thus enabling fluid from the fluid tank 164 to flow into the fluid reservoir 154. A spray nozzle 170, FIG. 1, is mounted at a forward surface of the fluid reservoir member 154 and may be angled at about 45° to the floor when the second relatively shorter handle portion 142 is in a vertical upright position. A valve member (not shown) positioned in the mouth 168 enables fluid from tank 164 to flow into a reservoir (not shown) within the reservoir member 154. The spray nozzle 170 may be positioned about 13 cm above the floor when the second handle portion 142 is in a vertical position. In operation of the fluid dispenser assembly 152, depressing the reciprocal pump member 160 causes fluid from the internal reservoir to be sprayed out the nozzle 170. The tip of nozzle 170 may be located about 5 cm forward of the longitudinal axis of the second handle portion 142. As best shown in FIGS. 2 and 3, the reservoir member 154 is positioned substantially entirely on the convex side 28 of the mop handle 20. Straight handled mops having a fluid dispenser assembly such as 152 are known in the art, such as, for example, floor mops available from Bona USA of 2550 South Parker Road, Aurora, Colo. 80014. Accordingly, the structure of the fluid dispenser assembly 152 will not be further described herein. In an alternative embodiment of the fluid dispenser assembly 152, the mechanical pump assembly is replaced by an aerosol spray assembly.

Second end 146 of the second relatively shorter handle portion 142 is pivotally mounted on a yoke member 172 as by a pin extending through sleeve portion 156 and end 146. Yoke member 172 is in turn pivotally mounted on a laterally extending shaft (not shown) which is mounted on a top portion 174 of mop head 12. Such universal joint mounting of a mop handle to a mop head is known in the art.

The operation of the cam member 82 and elongate cam follower 106 will now be described. FIG. 5 illustrates a position of the cam member 82 at which the cam member 82 has rotated as far as possible in the clockwise direction 180. The rotation of the cam member 82 in the clockwise direction 180 is limited by the engagement of the toe portion 94 of the cam member 82 with the interior side wall 178 of the first handle portion 42. At this relatively rotated position, the trigger portion 96 of the cam member 82 is rotated outwardly from the first handle member 42, for example, it may be rotated outwardly about 30°-45°. Rotation of the cam member 82 in the counter clockwise direction shown at 181 in FIG. 5, causes the elongate cam follower 106 to be displaced in direction 182, i.e., downwardly toward the pump member 160. In the position shown in FIG. 6, the elongate cam follower has moved in direction 182 and has depressed the pump member 160 so as to cause fluid to be dispensed from nozzle 170 by the mechanical pump assembly 158. The reciprocal pump member 160 is biased upwardly and thus when pressure is removed from trigger portion 96, the cam follower 106 will be moved by the pump member 160 in direction 186 and the cam member 82 will in turn be rotated in direction 180 until the cam follower 106 and the cam member 82 have returned to the position illustrated in FIG. 5. Thus, it will be seen that the cam member 82 and the cam follower 106 comprise portions of an actuator assembly that actuates the fluid dispenser assembly 152 to dispense fluid, such as in a spray mist 190, shown in FIGS. 2 and 3, onto the floor 200.

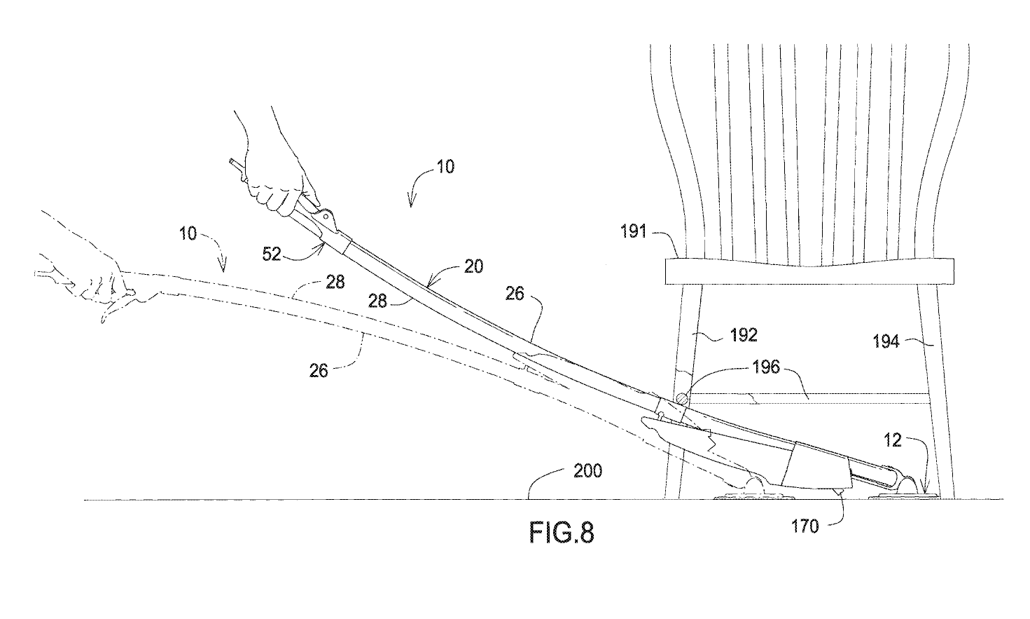

The floor mop 10 has a first operating position, shown in FIG. 2, which is the normal operating position of the mop. In this operating position, the convex side 28 of the bow shaped mop handle 20 is positioned above the concave side 26 and spray 190 from nozzle 170 is sprayed on the floor 200 at a position adjacent to the leading edge 16 of the mop head 12. In a second operating position of the mop 10, the concave side 26 is positioned above the convex side 28 and spray 190 from the nozzle is, again, deposited on the floor adjacent to the leading edge 16 of the mop head 12. In the second operating position, the spray nozzle 170 is closer to the floor than in the first operating position. This second operating position shown in FIGS. 3 and 8 can be used advantageously for cleaning a floor surface 200 below furniture 191 such as a chair, table or the like having legs 192, 194, etc. and a relatively low horizontal structure 196 such as the cross brace of a chair or table. In this configuration as shown in FIG. 8, the curvature of the mop handle 20 allows the mop head 12 to be positioned underneath the piece of furniture with the handle grip assembly 52 positioned at a relatively higher location that it would occupy if the mop were operated in the convex side up orientation as shown in phantom lines in FIG. 8. This position shown in FIG. 8 is also higher than that which would be provided by a mop having a straight mop handle. It will also be seen that by operating the mop 10 in the position shown in FIG. 8 that the fluid dispenser assembly 152 is positioned on the side of the mop 10 away from the horizontal structure 196 on the furniture 191 thus avoiding interference from the furniture. In one embodiment, the maximum forward extension of the fluid dispensing assembly is at a point 151 which may be about 8 cm from the central longitudinal axis of second handle portion 142 and about 25 cm from the floor 200 when the handle portion 142 is vertically upright.

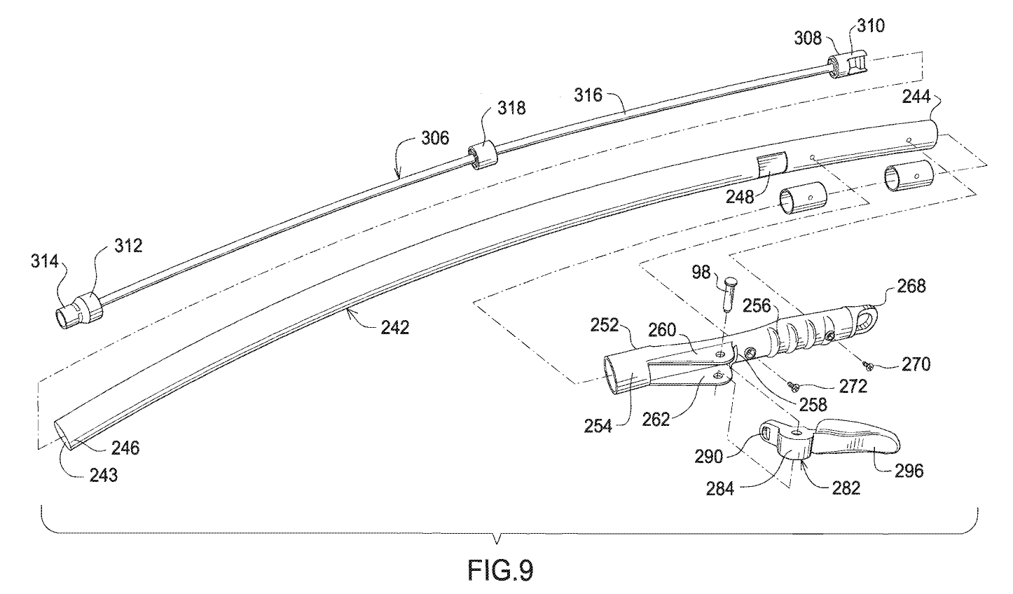

One embodiment of the bow shaped handle first handle portion 42 is shown in FIGS. 4-6 discussed above. A second embodiment of the first handle portion is shown in FIGS. 9-11. In this second embodiment the handle first portion is designated 242. The first handle portion 242 may be a tubular member having a cylindrical cavity 243, a first end 244 and a second end 246. A cut out 248 is provided near first end 244. A grip member 252 is mounted at the first end 244 of the first handle portion 242. The grip member 252 may have a sleeve portion 254 and an elongate portion 256 with an arcuate cross section adapted to fit closely against first handle portion 242. A cut out 258 is provided in the elongate portion 256, which is generally the same size as cut out 248. Cam mounting flanges 260, 262 are provided on the elongate portion 256 near sleeve portion 254. An end ring 268 may be provided at a terminal end of the grip member 252. The grip member 252 may be attached to the first handle portion 242 as by screws 270, 272.

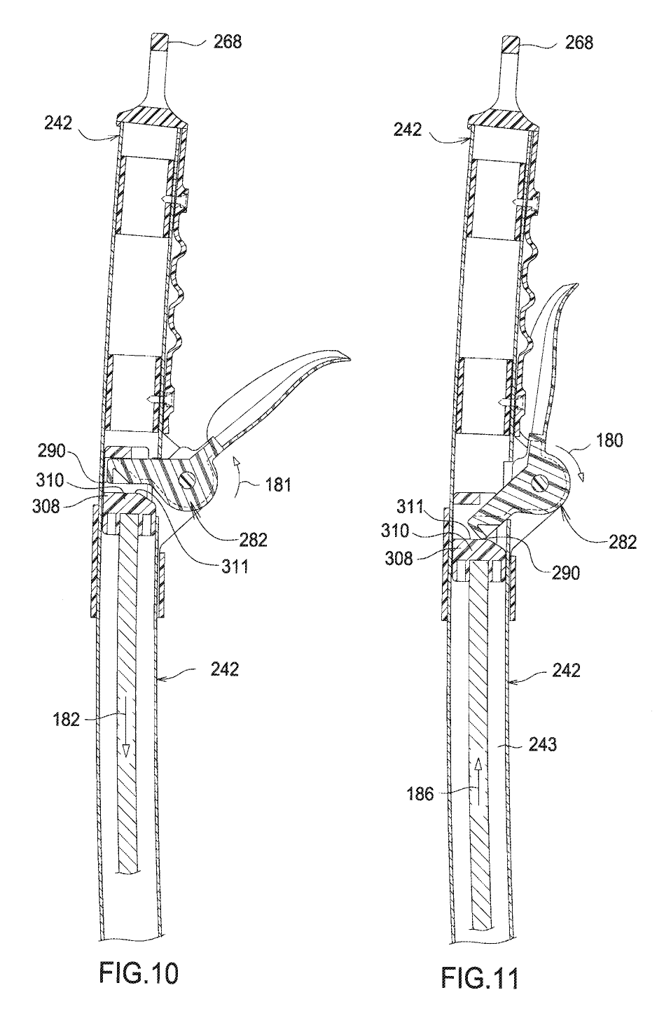

A cam member 282 has a central body portion 284 with a hole extending through it. A first end of the cam member 282 has a cam surface 290. The cam member 282 includes an elongate trigger portion 296 at its second end. A pin 298 is received in holes in the mounting flanges 260, 262 and the hole in the central body portion 284 to pivotally connect the cam member 282 to the grip member 252. An arcuate, elongate cam follower 306 has a first end 308 at which a cam engaging member 310 is located and a second end 312 at which a reciprocal pump member engaging member 314 is located. A relatively rigid, arcuate shaft 316, which may be constructed from metal such as aluminum, copper, steel or the like, may connect member 310 to member 314. The shaft 316 conforms to the arcuate shape of first handle portion 242 and may have one or more spacers 318 mounted thereon adapted to be closely slidingly received within cavity 243. A surface 311 of cam engaging member 310 engages surface 290 of the cam member 282, FIGS. 10 and 11.

Application of force to trigger portion 296 of cam member 282 causes rotation of the cam member 282 in direction 180, FIG. 10, causing the arcuate elongate cam follower 306 to displace the reciprocal pump member 160 downwardly in direction 182, thereby causing a fluid discharge as previously described. The upward bias force exerted by reciprocal pump member 160, when pressure is released from trigger portion 296, causes cam follower 306 to move in direction 186, thereby rotating cam member 282 in direction 180. The rotation of cam member 282 may be limited by edge portions of cut out 248. Prior art floor mops with straight handles, having fluid dispensers mounted thereon but having non-arcuate, elongate cam followers, have similar structure and operate in a manner similar to that described in this paragraph.

Although certain embodiments of the invention have been specifically described herein, it will be apparent to those having skill in the art after reading this disclosure that the invention may be variously otherwise embodied. The appended claims are to be construed to cover all such alternative embodiments and equivalents, except insofar as limited by the prior art.

What is claimed is:

1. A floor mop comprising:
a mop head;
a bow shaped handle having a distal end positioned remote from said mop head, a proximal end pivotably attached to said mop head, a concave side and a convex side opposite said concave side; said bow shaped handle being pivotably displaceable relative said mop head between a convex side up operating position in which said convex side is positioned above said concave side and a concave side up operating position in which said concave side is positioned above said convex side; and
a fluid dispenser mounted on said bow shaped handle.

2. The floor mop of claim 1 wherein said fluid dispenser is positioned substantially on said convex side of said bow shaped handle.

3. The floor mop of claim 1 wherein said bow shaped handle comprises:
a relatively longer first handle portion having a first end and a second end;
a relatively shorter second handle portion having a first end operably connected to said second end of said first handle portion and a second end pivotably connected to said mop head;
a fluid dispenser operatively associated with said second handle portion;
an actuator assembly operably connected to said fluid dispenser to actuate said fluid dispenser to dispense fluid; at least a portion of said actuator being disposed in said first handle portion.

4. The floor mop of claim 3 wherein said second handle portion is straight.

5. The floor mop of claim 3 wherein said actuator comprises:
a cam member pivotably mounted on said first handle portion;
an elongate cam follower member mounted within said first handle portion and linearly displaceable in response to pivotal displacement of said cam member.

6. The floor mop of claim 5 wherein said actuator assembly comprises a reciprocal member, engagable with and displaceable by said elongate cam follower member.

7. The floor mop of claim 6 wherein said cam member comprises a trigger portion.

8. The floor mop of claim 6 wherein said reciprocal member comprises a portion of a mechanical pump.

9. A floor mop comprising:
a mop head:
a tubular handle pivotally displaceable relative said mop head;
a fluid dispenser operably associated with said handle and having a reciprocal member adapted to dispense fluid from said fluid dispenser in response to being displaced in a first direction;
a cam member pivotably mounted on said tubular handle;
a cam follower member positioned inside said tubular handle said cam follower member having a first end operably engaging said cam member and having a second end engaging said reciprocal member;
wherein pivotal displacement of said cam member linearly displaces said cam follower which displaces said reciprocal member in said first direction to dispense fluid from said fluid dispenser;
wherein said tubular handle is a bow shaped handle having a convex side and a concave side and wherein said fluid dispenser is operable to dispense fluid onto a floor being mopped with said tubular handle in a convex side up operating position in which said convex side is positioned above said concave side and in a concave side up operating position in which said concave side is positioned above said convex side.

10. The floor mop of claim 9 wherein said tubular handle has a proximal end positioned proximate said mop head and a distal end and wherein said cam member comprises a cam surface positioned substantially within said tubular handle and a trigger portion positioned substantially outside said tubular handle.

11. The floor mop of claim 10 wherein said cam member is positioned proximate said distal end of said tubular member.

12. The floor mop of claim 11 wherein said fluid dispenser is positioned proximate said proximal end of said tubular handle and substantially on said concave side of said tubular handle.

13. The floor mop of claim 10 wherein said trigger portion comprises a first operating position in which said trigger portion is positioned substantially parallel to an adjacent portion of said bow shaped handle.

14. A method of cleaning a floor with a mop having a bow shaped handle with a convex side and a concave side and which is pivotally displaceable relative to a mop head comprising:
pushing the mop head across the floor with the bow shaped handle in a convex side up orientation;
when encountering furniture with legs and a generally horizontally disposed structure mounted on the legs, pivoting the mop head to a position with the bow shaped handle in a concave side up orientation; and
pushing the mop head over the floor beneath the generally horizontally disposed structure of the furniture; and
dispensing fluid from a fluid dispensing unit mounted on the mop handle.

15. The method of claim 14 further comprising:
dispensing fluid from a fluid dispensing unit mounted on the mop while pushing the mop head across the floor in a concave side up orientation; and
dispensing fluid from the fluid dispensing unit on the mop while pushing the mop head across the floor in a concave side up orientation.

16. The method of claim 15 wherein said dispensing fluid from a fluid dispensing unit on the mop comprises displacing a trigger until it is generally parallel to the convex side of the bow shaped handle.
